(19) United States
(12) Patent Application Publication
(10) Pub. No.: US 2019/0179867 A1
(43) Pub. Date: Jun. 13, 2019

(54) METHOD AND SYSTEM FOR ANALYZING MEASUREMENT-YIELD CORRELATION

(71) Applicant: SK HOLDING CO., LTD., Seoul (KR)

(72) Inventors: Tae Young HONG, Seongnam-si (KR); Byung Min LEE, Cheonan-si (KR); Sung Tae KIM, Goyang-si (KR)

(73) Assignee: SK HOLDING CO., LTD., Seoul (KR)

(21) Appl. No.: 16/324,226

(22) PCT Filed: Aug. 7, 2017
(86) PCT No.: PCT/KR2017/008500

§ 371 Date: Feb. 8, 2019

(30) Foreign Application Priority Data
Aug. 11, 2016 (KR) 10-2016-0102112

(51) Int. Cl. G06F 17/15; G06F 16/906; G05B 19/418

(52) U.S. Cl. CPC G06F 17/15; G06F 17/18; G05B 19/41875; G06F 16/906

(57) ABSTRACT

A method and a system for analyzing a measurement-yield correlation are provided. The method for analyzing a measurement-yield correlation according to an embodiment of the present invention derives a first yield prediction function by using measurement-yield data which are data pairs of process result data measured after performing a process and actual yield data for each of the collected process result data, extracts some of the measurement-yield data by using a first yield prediction function, and subsequently derives a second yield prediction function by using the extracted measurement-yield data. As such, the measurement-yield correlation indicating high correlation/reliability can be derived, so that a final yield can be predicted relatively accurately from the process result data measured after performing the process.

### TECHNICAL FIELD

The present disclosure relates to analysis technology, and more particularly, to a method and a system for analyzing a correlation between data measured in a process of manufacturing a semiconductor, a display, or the like, and a yield.

### BACKGROUND ART

In the industry for mass-producing through a plurality of processes such as semiconductor industry, occurrence of a quality abnormality is monitored between important processes to guarantee process stability.

Accordingly, a quality abnormality is monitored based on process result data which is obtained by measuring characteristics of wafers completed until a specific process, and an alarm is generated when the quality abnormality occurs.

The generated alarm may be a genuine alarm that is generated since the quality abnormality actually influences a final yield, but it may be a false alarm. Therefore, it should be determined whether the alarm is the genuine alarm or the false alarm.

To distinguish between the genuine alarm and the false alarm, it should be determined whether the process result data greatly influences the final yield, and to achieve this, a measurement-yield correlation is analyzed. However, the distribution of process result data may be so wide that it is difficult to find the correlation.

### DISCLOSURE

### Technical Problem

The present disclosure has been developed in order to address the above-discussed deficiencies of the prior art, and an object of the present disclosure is to provide a method and a system for providing a measurement-yield correlation having high correlation/reliability to provide an accurate index regarding an influence of process result data measured after performing a process on a yield.

### Technical Solution

According to an embodiment of the present disclosure to achieve the above-described objects, a measurement-yield correlation analysis method includes: a step of collecting process result data measured after a process is performed; a step of collecting real yield data regarding each of the collected process result data; a first deriving step of deriving a first yield prediction function by using measurement-yield data which is a data pair of the measured process result data and the real yield data; a step of extracting a part of the measurement-yield data by using the first yield prediction function; and a second deriving step of deriving a second yield prediction function by using the extracted measurement-yield data.

In addition, the first deriving step may include: a first grouping step of grouping the measurement-yield data to a plurality of groups; a first selection step of selecting representative data from the respective groups; and a step of deriving the first yield prediction function by using the selected representative data.

In addition, the second driving step may include: a second grouping step of grouping the extracted measurement-yield data to a plurality of groups; a second selection step of selecting representative data from the respective groups; and a step of deriving the second yield prediction function by using the selected representative data.

In addition, the representative data may be measurement-yield data having maximum real yield data.

In addition, the yield prediction function may be a maximum yield prediction function.

In addition, a number of groups grouped at the first grouping step may be different from a number of groups grouped at the second grouping step.

In addition, the first selection step and the second selection step may not select representative data from a group that does not include measurement-yield data.

In addition, the step of extracting may extract a part of the measurement-yield data based on a result of comparing “real yield data regarding process result data” and “predicted yield data calculated by putting the process result data to the first yield prediction function.”

In addition, the result of the comparing may be a result of comparing an absolute difference between the “real yield data regarding the process result data” and the “predicted yield data calculated by putting the process result data to the first yield prediction function,” with a threshold value.

The threshold value may be a representative value calculated from the absolute differences.

The process may be any one of a plurality of processes constituting a manufacturing process.

The manufacturing process may be a process of manufacturing a semiconductor or a display.

According to another embodiment of the present disclosure, a measurement-yield correlation analysis system includes: a collector configured to collect process result data measured after a process is performed, and real yield data regarding each of the collected process result data; and a processor configured to derive a first yield prediction function by using measurement-yield data which is a data pair of the measured process result data and the real yield data, to extract a part of the measurement-yield data by using the first yield prediction function, and to derive a second yield prediction function by using the extracted measurement-yield data.

### Advantageous Effects

According to embodiments of the present disclosure as described above, a measurement-yield correlation having high correlation/reliability can be provided, and thus a final output can be relatively accurately predicted from process result data measured after a process is performed.

Accordingly, when an interlock occurs due to abnormal data measurement, it can be determined whether an alarm caused by the abnormal data measurement is a genuine alarm or a false alarm, and also, a process having a high correlation with/influence on a yield can be grasped and measures such as intensive management can be made to the process.

In particular, according to embodiments of the present disclosure, maximum yield data is selected from each process result data section, such that an influence of process result data of a different section can be minimized.

In addition, according to various embodiments of the present disclosure, the maximum yield prediction function is derived by performing regression analysis two times. Unlike the first regression analysis, the second regression analysis is performed after measurement-yield data corresponding to a noise is removed, such that a maximum yield prediction function of high accuracy/reliability can be derived.

### DESCRIPTION OF DRAWINGS

FIG. 1 is a flowchart provided to explain a measurement-yield correlation analysis method according to an embodiment of the present disclosure;

FIG. 2 is a view to illustrate process result data and real yield data;

FIG. 3 is a view illustrating a result of dividing measurement-yield data into 12 equal parts;

FIG. 4 is a view illustrating a result of selecting maximum yield data of each group;

FIG. 5 is a view suggesting a maximum yield prediction function derived by using regression analysis;

FIG. 6 is a view provided to explain a method for extracting only valid data by removing a noise from measurement-yield data;

FIG. 7 is a view illustrating a result of dividing measurement-yield data into 24 equal parts;

FIG. 8 is a view illustrating a result of selecting maximum yield data of each group;

FIG. 9 is a view suggesting a maximum yield prediction function derived by using regression analysis; and

FIG. 10 is a block diagram of a correlation analysis system according to another embodiment of the present disclosure.

### BEST MODE

Hereinafter, the present disclosure will be described in more detail with reference to the drawings.

Embodiments of the present disclosure suggest a method for analyzing a measurement-yield correlation. The “measurement-yield correlation” refers to a correlation between process result data measured when a manufacturing process is completed until a process of a specific order, and a yield

When the analysis of the measurement-yield correlation is completed, a maximum yield may be predicted from the process result data. For example, by using the result of analyzing the measurement-yield correlation, a maximum yield of “95.2%” may be predicted from process result data of “6.7,” and a maximum yield of “88.5%” may be predicted from process result data of “5.5.”

Furthermore, when an interlock occurs due to an abnormality in measurement, it may be determined whether an alarm caused by abnormal data measurement is a genuine alarm or a false alarm by using the result of analyzing the measurement-yield correlation.

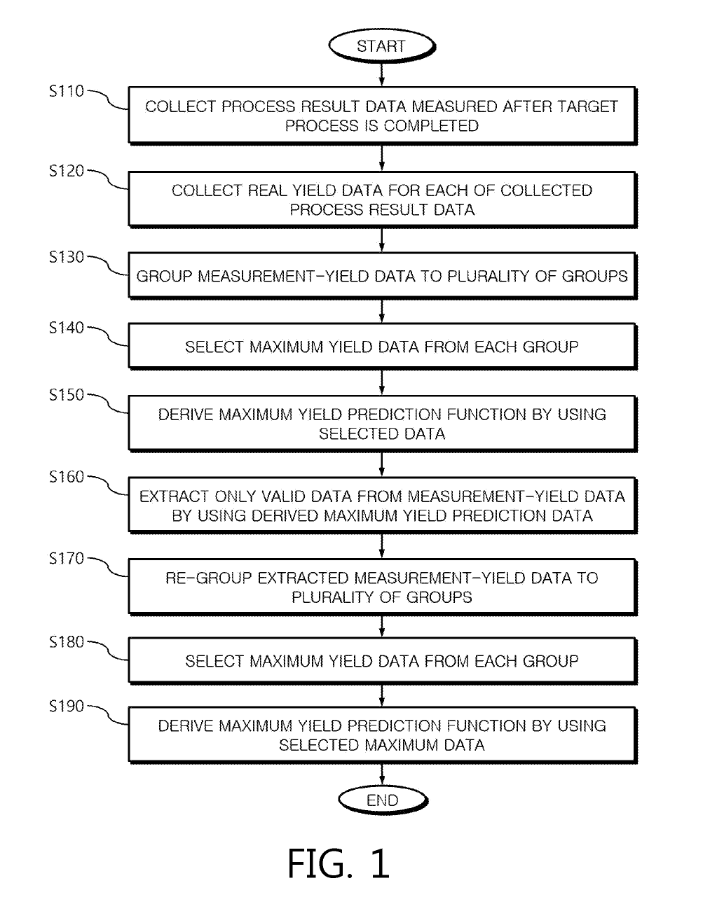

FIG. 1 is a flowchart provided to explain a measurement-yield correlation analysis method according to an embodiment of the present disclosure. The illustrated method is performed by a measurement-yield correlation analysis system (hereinafter, referred to as a “correlation analysis system”), which is a kind of a computing system.

As shown in FIG. 1, first, the correlation analysis system collects process result data which is measured after a target process for analyzing a correlation with a yield is completed (S110).

Thereafter, after all manufacturing processes are completed, real yield data corresponding to the respective process result data collected at step S110 is collected (S120).

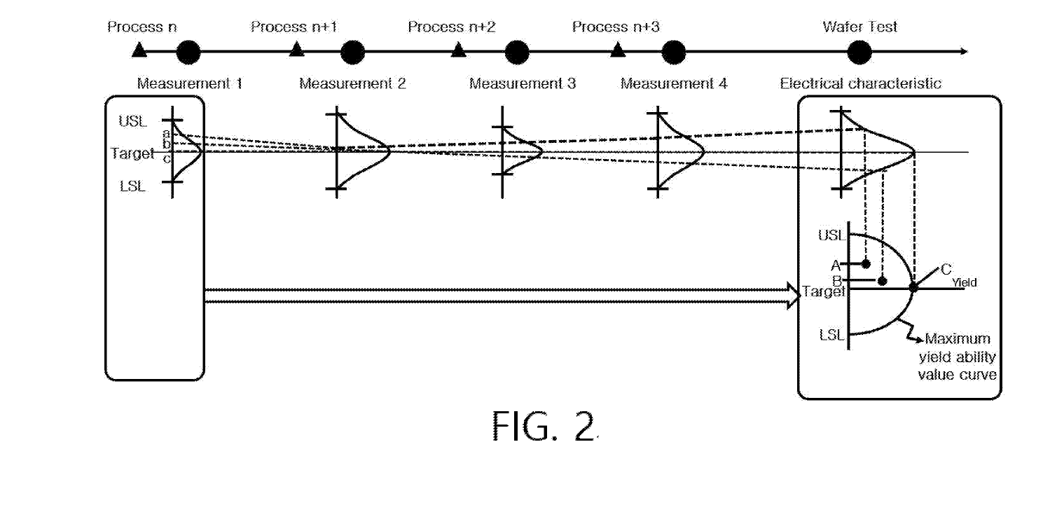

FIG. 2 illustrates process result data “a,” “b,” “c” which are measured after a process “n” for analyzing a correlation with a yield is completed, and real yield data “A,” “B,” “C” corresponding to the process result data, respectively.

Data “a,” “b,” “c” correspond to the data collected at step S110, and data “A,” “B,” “C” correspond to the data collected at step S120. FIG. 2 illustrates only three pairs of data for convenience of illustration. However, there may be a large number of pairs of data.

A maximum yield ability value curve indicating a maximum yield regarding process result data, shown on the right lower portion of FIG. 2, is a final output of the measurement-yield correlation analysis method according to an embodiment of the present disclosure, and hereinafter, will be referred to as a maximum yield prediction function.

By collecting data at steps S110 and S120, the correlation analysis system obtains “pairs of measured process result data and real yield data” (hereinafter, referred to as “measurement-yield data”).

Thereafter, the correlation analysis system groups the measurement-yield data to a plurality of groups (S130). A criterion for grouping is the process result data. That is, measurement-yield data having similar process result data are grouped.

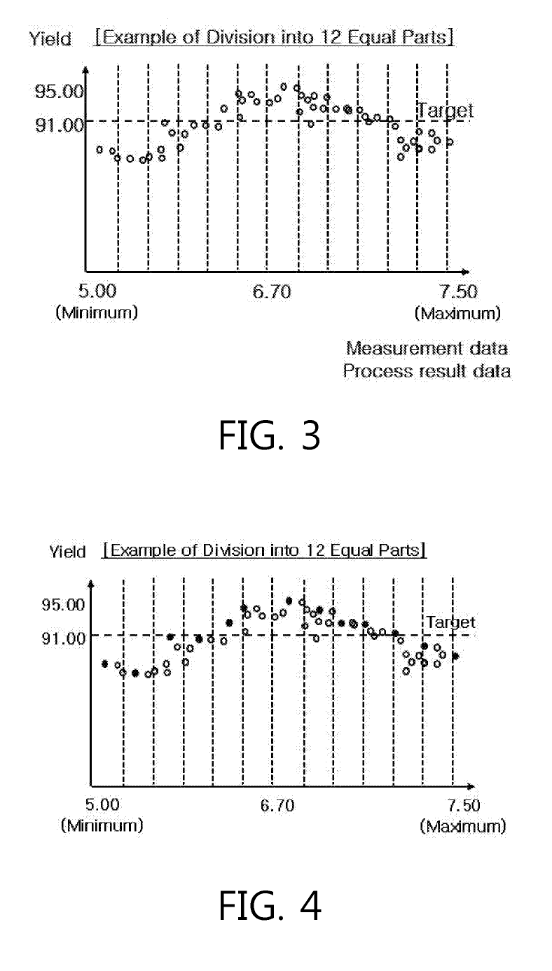

More specifically, as shown in FIG. 3, a section from minimum process result data to maximum process result data may be divided into 12 equal parts, and the measurement-yield data are grouped to 13 groups.

Next, the correlation analysis system selects maximum yield data from each group (S140). From a group that does not include measurement-yield data, maximum yield data is not selected.

FIG. 4 illustrates a result of selecting maximum yield data from each group. In FIG. 4, measurement-yield data indicated by “•” correspond to maximum yield data in corresponding groups.

Thereafter, the correlation analysis system derives a maximum yield prediction function by using the maximum data selected at step S140 (S150). To derive the maximum yield prediction function, regression analysis may be utilized with respect to the maximum yield data.

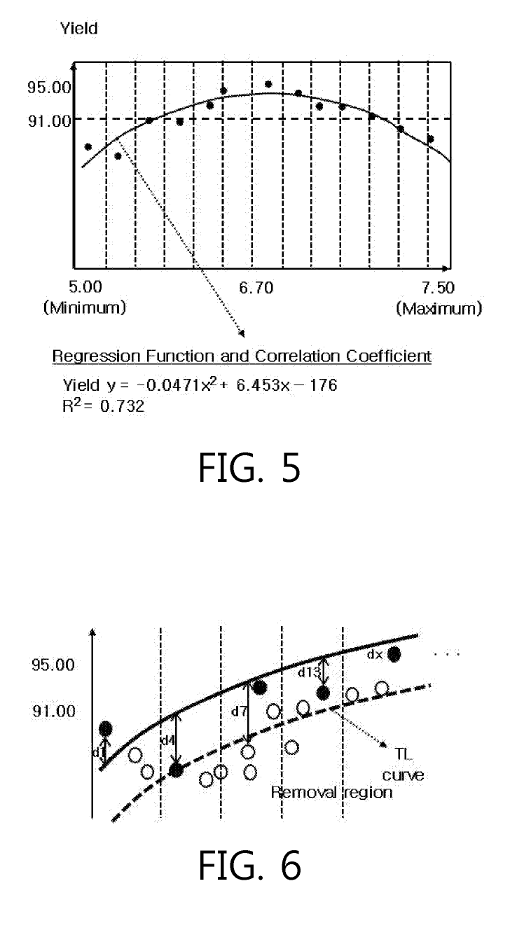

FIG. 5 suggests the maximum yield prediction function derived by regression analysis. In this process, a correlation coefficient between the maximum yield data and the derived maximum yield prediction function is obtained.

Next, the correlation analysis system extracts only valid data from the measurement-yield data collected at steps S110 and S120 by using the maximum yield prediction function derived at step S150 (S160).

Step S160 corresponds to a process of removing data corresponding to a noise from the collected measurement-yield data. To achieve this, a tolerance limit (TL) is calculated based on the following equation.

TL=median(d1˜dn)

where d is an absolute difference between “real yield data regarding process result data” and “predicted yield data calculated by putting the process result data to the maximum yield prediction function,” as shown in FIG. 6 In addition, median is a median value, and n is the number of collected measurement-yield data.

In addition, as shown in FIG. 6, measurement-yield data in which “an absolute difference between predicted yield data regarding process result data, and real yield data” is larger than “TL” is removed. That is, at step S160, only measurement-yield data in which an “absolute difference between predicted yield data regarding process result data, and real yield data” is less than or equal to “TL” is abstracted.

Since the TL is a median value, half of the measurement-yield data is removed. As the TL, a mean value rather than the median value may be applied, and a value applying a weight (0˜1) to the mean value may be applied.

Thereafter, the correlation analysis system re-groups the measurement-yield data extracted at step S160 to a plurality of groups (S170). As at step S130, a grouping criterion is the process result data.

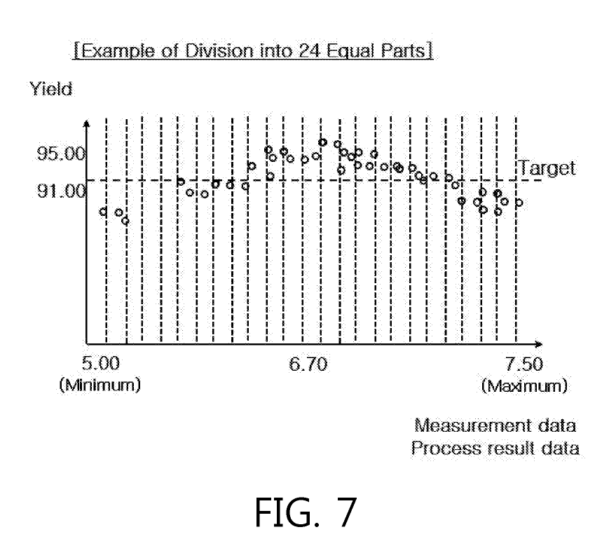

However, as shown in FIG. 7, grouping at step S170 is dividing the data into 24 equal parts, which are larger than the number of divided parts at step S130, that is, 12. This is an optional matter, and grouping may be differently implemented. That is, the number of divided parts may be equal to or smaller than that at step S130.

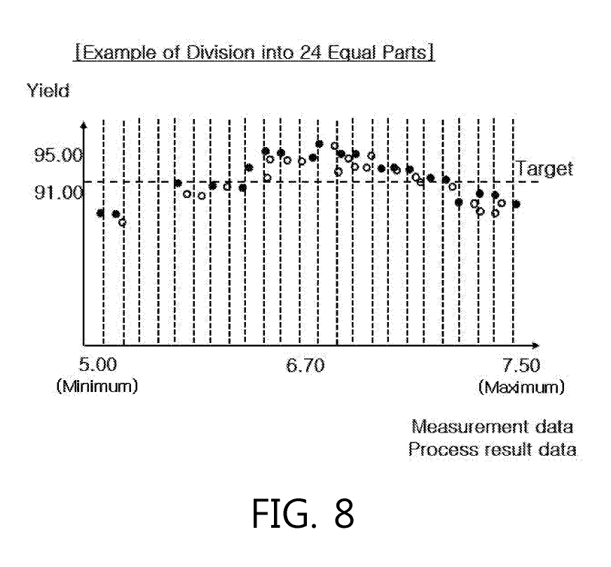

Next, the correlation analysis system selects maximum yield data from each group (S180). As at step S140, from a group that does not include measurement-yield data, maximum yield data is not selected. FIG. 8 illustrates a result of selecting maximum yield data from each group.

Thereafter, the correlation analysis system derives a maximum yield prediction function by using the maximum data selected at step S180 (S190). As at step S150, regression analysis may be utilized with respect to the maximum yield data to derive the maximum yield prediction function.

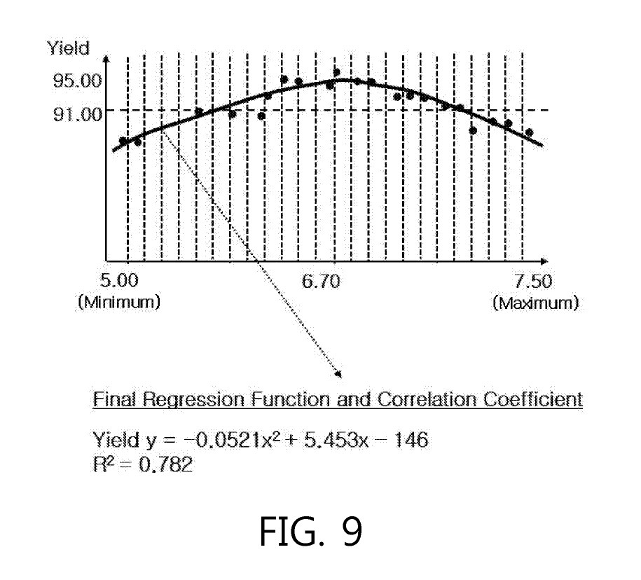

FIG. 9 suggests the maximum yield prediction function derived by using regression analysis.

The measurement-yield correction analysis method has been described up to now with reference to preferred embodiments.

The maximum yield prediction function (maximum yield ability value curve), which is an output of the measurement-yield correlation analysis method according to an embodiment of the present disclosure, is able to predict a yield based on a correlation between process result data measured at a specific processing step and a yield.

In addition, when an interlock occurs due to abnormal data measurement, it can be determined whether an alarm caused by the abnormal data measurement is a genuine alarm or a false alarm, and also, a process having a high correlation with/influence on a yield can be grasped and measures such as intensive management can be made to the process.

In an embodiment of the present disclosure, maximum yield data is selected from each group, that is, is selected from each process result data section. This can minimize an influence of process result data of a different section.

In addition, the maximum yield prediction function is derived by performing regression analysis two times. Unlike the first regression analysis, the second regression analysis is performed after measurement-yield data corresponding to a noise is removed, such that accuracy/reliability of the maximum yield prediction function can be enhanced.

The measurement-yield correlation analysis method according to an embodiment of the present disclosure may be widely applied to manufacturing of semiconductors, displays, and other devices.

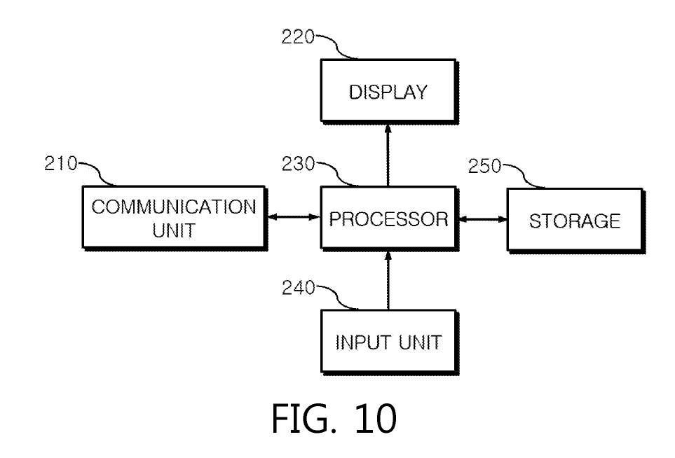

The correlation analysis system capable of performing the measurement-yield correlation analysis method according to an embodiment of the present disclosure will be described in detail with reference to FIG. 10. FIG. 10 is a block diagram of the correlation analysis system according to another embodiment of the present disclosure.

The correlation analysis system according to an embodiment of the present disclosure includes a communication unit 210, a display 220, a processor 230, an input unit 240, and a storage 250 as shown in FIG. 10.

The communication unit 210 is a means for communicating data by connecting communication with an external device or an external network.

The display 220 is a means for displaying information, and the input unit 240 is a means for inputting information. The display 220 and the input unit 240 may be integrated into a touch screen, and this is more useful when the correlation analysis system is of a mobile type.

The above-described process result data and real yield data may be received from a measurement device/network through the communication unit 210, or may be collected by being received through the input unit 240. Therefore, the communication unit 210 and the input unit 240 function as data collecting means.

Furthermore, a dividing criterion for grouping the measurement-yield data, and a tolerance limit (TL) for selecting only valid data from the measurement-yield data may be received through the communication unit 210, or may be inputted through the input unit 240.

The processor 230 performs the correlation analysis algorithm illustrated in FIG. 1 by using the received/inputted data, criterion, condition, or the like, and may display a result of performing through the display 220 or may deliver the result to an external device/network through the communication unit 210.

The storage 250 provides a storage space necessary for the processor 230 to perform the correlation analysis algorithm.

The technical idea of the present disclosure may be applied to a computer-readable recording medium which records a computer program for performing the functions of the apparatus and the method according to the present embodiment. In addition, the technical idea according to various embodiments of the present disclosure may be implemented in the form of a computer-readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer-readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

1. A measurement-yield correlation analysis method comprising:
a step of collecting process result data measured after a process is performed;
a step of collecting real yield data regarding each of the collected process result data;
a first deriving step of deriving a first yield prediction function by using measurement-yield data which is a data pair of the measured process result data and the real yield data;
a step of extracting a part of the measurement-yield data by using the first yield prediction function; and
a second deriving step of deriving a second yield prediction function by using the extracted measurement-yield data.

2. The method of claim 1, wherein the first deriving step comprises:
a first grouping step of grouping the measurement-yield data to a plurality of groups;
a first selection step of selecting representative data from the respective groups; and
a step of deriving the first yield prediction function by using the selected representative data.

3. The method of claim 2, wherein the second driving step comprises:
a second grouping step of grouping the extracted measurement-yield data to a plurality of groups;
a second selection step of selecting representative data from the respective groups; and
a step of deriving the second yield prediction function by using the selected representative data.

4. The method of claim 3, wherein the representative data is measurement-yield data having maximum real yield data, and the yield prediction function is a maximum yield prediction function.

5. The method of claim 3, wherein a number of groups grouped at the first grouping step is different from a number of groups grouped at the second grouping step.

6. The method of claim 3, wherein the first selection step and the second selection step do not select representative data from a group that does not include measurement-yield data.

7. The method of claim 3, wherein the step of extracting extracts a part of the measurement-yield data based on a result of comparing “real yield data regarding process result data” and “predicted yield data calculated by putting the process result data to the first yield prediction function.”

8. The method of claim 7, wherein the result of the comparing is a result of comparing an absolute difference between the “real yield data regarding the process result data” and the “predicted yield data calculated by putting the process result data to the first yield prediction function,” with a threshold value.

9. The method of claim 8, wherein the threshold value is a representative value calculated from the absolute differences.

10. The method of claim 1, wherein the process is any one of a plurality of processes constituting a manufacturing process.

11. The method of claim 9, wherein the manufacturing process is a process of manufacturing a semiconductor or a display.

12. A measurement-yield correlation analysis system comprising:
a collector configured to collect process result data measured after a process is performed, and real yield data regarding each of the collected process result data; and
a processor configured to derive a first yield prediction function by using measurement-yield data which is a data pair of the measured process result data and the real yield data, to extract a part of the measurement-yield data by using the first yield prediction function, and to derive a second yield prediction function by using the extracted measurement-yield data.
